(19) United States
(12) Patent Application Publication
(10) Pub. No.: US 2012/0153856 A1
(43) Pub. Date: Jun. 21, 2012

(54) DRIVING DEVICE OF LIGHT EMITTING DIODE AND LIGHTING APPARATUS USING THE SAME

(75) Inventors: Yao-Sheng Liu, New Taipei City (TW); Hung-Yen Su, New Taipei City (TW); Hao-Yung Wang, New Taipei City (TW)

(73) Assignees: Kinpo Electronics, Inc., New Taipei City (TW); Cal-Comp Electronics & Communications Company Limited, New Taipei City (TW)

(21) Appl. No.: 13/281,428

(22) Filed: Oct. 26, 2011

(30) Foreign Application Priority Data
Dec. 15, 2010 (TW) 99224346

(51) Int. Cl. H05B 37/02

(52) U.S. Cl. 315/219

(57) ABSTRACT

A driving device of a Light Emitting Diode (LED) and a lighting apparatus using the same are provided. The driving device of the LED is adapted for receiving an Alternating Current (AC) power source adjusted by a dimmer and a transformer unit, and includes a dimming driving unit and a voltage multiplier unit. The dimming driving unit receives a driving Direct Current (DC) power source produced by the voltage multiplier unit, so as to drive and adjust the brightness of a light source of an LED unit. The voltage multiplier unit multiplies the AC power source according to a power specification of the dimming driving unit, so as to transform and supply the driving DC power source to the dimming driving unit, and thus flicker on the light source of the LED unit can be avoided during dimming.

### CROSS-REFERENCE TO RELATED APPLICATION

This application claims the priority benefit of Taiwan application serial no. 99224346, filed on Dec. 15, 2010. The entirety of the above-mentioned patent application is hereby incorporated by reference herein and made a part of this specification.

### BACKGROUND OF THE INVENTION

1. Field of the Invention

The present invention relates to a lighting technology of a Light Emitting Diode (LED). Particularly, the invention relates to a driving device of an LED and a lighting apparatus using the same.

2. Description of Related Art

In the lighting technology, a dimmer, for example, a Tri-electrode Alternating Current (AC) switch (TRIAC), is used to adjust the brightness of a lighting apparatus. The dimmer may provide a voltage according to a conducting condition to slightly adjust the light emitting effect of a resistive light emitting element (for example, a halide lamp or a tungsten lamp) of the lighting apparatus. The household dimmer may be disposed separately from the lighting apparatus, for example, the dimmer is disposed at an appropriate position of the wall, such that users may easily adjust the brightness of the lamp light.

In addition, with the technical demands of energy saving and carbon reduction, an LED, characterized in having a small size and being power saving and durable, and also having a low cost due to improvement of the manufacturing process and the production output of the LED, gradually becomes the light source of a new generation. The LED has a low working voltage and is capable of actively emit lights with certain brightness, in which the brightness may be adjusted by a voltage or current, and the LED further features in impact resistance, anti-vibration, and a long service life (one hundred thousand hours). Therefore, the LED is widely applied in various terminal apparatuses and lighting fields, such as automobile headlights, traffic lights, text displays, billboards, large screen video displays, common level building lights, LCD backlights, and other fields.

In consideration of cost saving, consumers generally expect to only replace a resistive bulb with an LED bulb instead of changing a base frame and a dimming switch of the original lighting apparatus, thereby saving the power consumption and avoiding the inconvenience of replacing the entire lighting apparatus. However, since a circuit characteristic of the LED present a capacitance characteristic, when the brightness of the light source of the LED bulb is controlled directly by the dimmer, flicker occurs in most cases.

### SUMMARY OF THE INVENTION

The invention is directed to a driving device of an LED and a lighting apparatus using the same, capable of stably controlling the brightness of a light source of an LED bulb by using a dimmer as a TRIAC, so that flicker on the light source of the LED can be avoided.

The invention provides a driving device of an LED, adapted for receiving an AC power source adjusted by a dimmer and a transformer unit. The driving device includes a dimming driving unit and a voltage multiplier unit. The dimming driving unit receives a driving Direct Current (DC) power source produced by the voltage multiplier unit, so as to drive and adjust the brightness of a light source of an LED unit. The voltage multiplier unit coupled to the dimming driving unit receives the AC power source, and multiplies the AC power source according to a power specification of the dimming driving unit, so as to transform and supply the driving DC power source to the dimming driving unit.

In an embodiment of the invention, the voltage multiplier unit includes a first voltage multiplier input terminal, a second voltage multiplier input terminal, a first voltage multiplier output terminal, and a second voltage multiplier output terminal. The first and the second voltage multiplier input terminals are used to receive the AC voltage, and the first and the second voltage multiplier output terminals are used to output the driving DC power source.

From another perspective, the invention provides a lighting apparatus of an LED. The lighting apparatus includes a dimming control unit and a driving device. The driving device includes a dimming driving unit and a voltage multiplier unit. The dimming control unit includes a dimmer and a transformer unit. The dimmer produces a dimming power source according to a conducting condition, and the transformer unit receives the dimming power source and adjusts the dimming power source to be an AC power source. The dimming driving unit receives the driving DC power source produced by the voltage multiplier unit, so as to drive and adjust the brightness of a light source of an LED unit. The voltage multiplier unit is coupled between the dimming control unit and the dimming driving unit, receives the AC power source, and multiplies the AC power source and transforms the AC power source into the driving DC power source according to a power specification of the dimming driving unit, thereby supplying the driving DC power source to the dimming driving unit.

In an embodiment of the invention, the driving device and the LED unit are an LED bulb of the lighting apparatus, and the dimming control unit is a dimming switch and a base frame part of the LED bulb.

In view of the above, in the lighting apparatus of the invention, in order to stably control the brightness of an LED unit through an AC power source produced by a dimming control unit, the AC power source is multiplied by a voltage multiplier unit to an operating voltage range of a dimming driving unit. In this manner, not only the dimming driving unit is enabled to successfully drive the LED unit, but also flicker on the light source of the LED unit can be avoided during dimming.

In order to make the aforementioned features and advantages of the invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a lighting apparatus of an LED according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

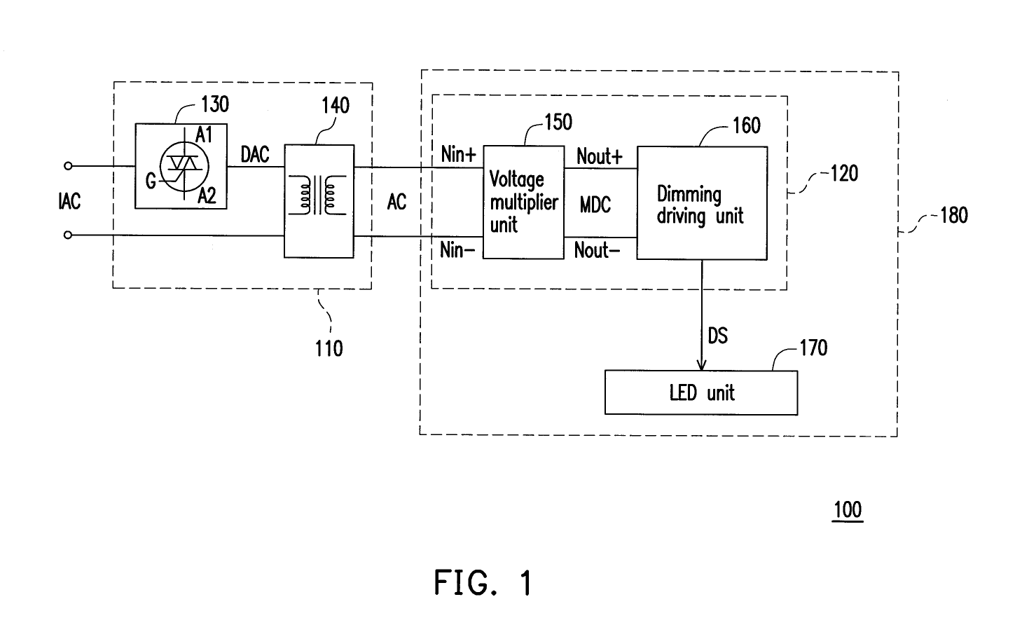

FIG. 1 is a block diagram of a lighting apparatus 100 of an LED according to an embodiment of the present invention. Referring to FIG. 1, in the applications of this embodiment, the lighting apparatus 100 may be considered as a lamp apparatus, for example, a table lamp or a ceiling lamp, a dimming control unit 110 may be considered as a dimming switch and a lamp base frame part of the lighting apparatus 100, and a driving device 120 and an LED unit 170 may be together considered as an LED bulb 180 of the lighting apparatus 100.

In this embodiment, the dimming control unit 110 includes a dimmer 130 and a transformer unit 140, and the driving device 120 includes a voltage multiplier unit 150 and a dimming driving unit 160. Basically, the dimmer 130 may adopt a TRIAC as its basic architecture. Further, the dimmer 130 may adjust a voltage waveform of terminal points A1 and A2 of the TRIAC in response to a conducting condition set by a user at a gate control terminal G of the TRIAC, so as to adjust an input power source IAC (for example, but not limited to, a commercial power of 120 V) to be a dimming power source DAC (for example, an effective voltage value of 120 V).

In addition, the transformer unit 140 may adopt an electronic transformer as its basic architecture. In this embodiment, the transformer unit 140 may receive the dimming power source DAC, and adjust the effective voltage value of the dimming power source DAC to be an AC power source AC (for example, but not limited to, 12 V). Thus, in the applications of the embodiment of the present invention, the dimming switch and the lamp base frame part of the lighting apparatus 100 may be formed by using the TRIAC and the electronic transformer, while the circuit architecture thereof is well-known by persons skilled in the art, and is not described herein again.

Here, the key point of the embodiment of the present invention is that in order to not replace the base frame and the dimming switch part of the lighting apparatus (that is, not change the dimming control unit 110, from which it is known that the dimming control unit 110 is already an unchangeable part), even if an old resistive bulb (for example, a halide lamp or a tungsten lamp) is replaced with a capacitive LED bulb 180, flicker does not occur on a light source provided by the LED bulb 180. In other words, the driving device 120 according to this embodiment is capable of driving and adjusting the brightness of the light source of the LED unit 170 according to the AC power source AC produced by the dimming control unit 110.

Further, the voltage multiplier unit 150 coupled between the dimming control unit 110 and the dimming driving unit 160 may receive the AC power source AC, multiply the AC power source AC (12 V), and transform the AC power source AC into the driving DC power source MDC (for example, but not limited to, multiply the AC power source AC of 12 V, and transform the AC power source AC to the driving DC power source MDC of 120 V), thereby enabling a voltage value of the driving DC power source MDC to satisfy an operating voltage range (for example, but not limited to, 120 V to 230 V) of a power specification of the dimming driving unit 160.

In this manner, the dimming driving unit 160 receives the driving DC power source MDC (the voltage value thereof is 120 V) transformed by the voltage multiplier unit 150, and accordingly produces a drive signal DS to drive and adjust the brightness of the light source of the LED unit 170. Thereby, the dimming driving unit 160 may successfully drive the LED unit 170, and the flicker on the light source provided by the LED bulb 180 can be avoided.

In this embodiment, a ten-time voltage multiplier circuit is used as an implementation manner of the voltage multiplier unit 150, but the circuit architecture and the implementation manner of the voltage multiplier unit 150 are not limited thereto. Persons skilled in the art may adjust a multiplying factor of the voltage multiplier unit 150 for the AC power source AC and the circuit architecture of the voltage multiplier unit 150 according to design demands and the power specification of the dimming driving unit 160, for example, adjust the multiplying factor to be 1-time, 2-time, 3-time, 4-time to N-time voltage multiplying, in which N is a real number. Further, persons skilled in the art may know that the adjusted multiplying factor of the voltage multiplier unit 150 for the AC power source AC may vary according to the increase or decrease and an arrangement order of diodes and capacitors in the circuit architecture of the voltage multiplier unit 150.

More specifically, as shown in FIG. 1, the voltage multiplier unit 150 has a voltage multiplier input terminal Nin+, a voltage multiplier input terminal Nin−, a voltage multiplier output terminal Nout+, and a voltage multiplier output terminal Nout−, and the voltage multiplier unit 150 may form the ten-time voltage multiplier circuit by using the circuit architecture of the diodes and the capacitors. The voltage multiplier input terminals Nin+ and Nin− are used to receive the AC voltage AC, and the voltage multiplier output terminals Nout+ and Nout− are used to output the driving DC power source MDC. In this manner, the voltage multiplier unit 150 may respectively charge the capacitors in the ten-time voltage multiplier circuit through positive and negative half-period waveforms of the AC power source AC (12 V), so as to transform and output the driving DC power source MDC (120 V) of 10-time voltage multiplying. Based on the above description, persons skilled in the art may deduce to obtain the voltage multiplier unit 150 satisfying the power specification of the dimming driving unit 160, and the details may not be given herein again.

Still referring to FIG. 1, in this embodiment, an LED driving chip is used as an implementation manner of the dimming driving unit 160, and the LED driving chip may be an LED driving chip designed by NS, NXP, or PI, for example, LM3445, but is not limited herein, that is to say, any LED driving chips of 120 V and 230 V having a dimmer function are applicable.

In view of the above, in the present invention, generally, the input power source IAC (for example, but not limited to, the commercial power of 120 V) flows through the dimmer 130 of a TRIAC, the transformer unit 140 of the electronic transformer lowers the input power source IAC to the AC voltage AC of 12 V, and then the voltage multiplier unit 150 rises the AC voltage AC of 12 V to match the LED driving chips of 120 V and 230 V. In this manner, the present invention may not only achieve the dimmer function of the dimmer 130 of the TRIAC, but also be applied to the product of MR16 series.

To sum up, in the lighting apparatus 100 of the present invention, in order to stably control the brightness of the light source of the LED unit 170 through the AC power source produced by the dimming control unit 110, the AC power source AC is multiplied and is transformed by the voltage multiplier unit 150 in the driving device 120 to the DC power source, such that the driving DC power source MDC produced after being multiplied is in the operating voltage range of the dimming driving unit 160. In this manner, not only the dimming driving unit 160 may successfully drive the LED unit 170, but also the flicker on the light source of the LED unit 170 can be avoided during dimming. Further, a dimming range of the dimmer 130 of the TRIAC may be up to 0:100.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving device of a Light Emitting Diode (LED), adapted for receiving an Alternating Current (AC) power source adjusted by a dimmer and a transformer unit, the driving device comprising:
a dimming driving unit, for receiving a driving Direct Current (DC) power source, so as to drive and adjust the brightness of a light source of an LED unit; and
a voltage multiplier unit, coupled to the dimming driving unit, for receiving the AC power source, and multiplying the AC power source and transforming the AC power source into the driving DC power source according to a power specification of the dimming driving unit.

2. The driving device of an LED according to claim 1, wherein the voltage multiplier unit comprises a first voltage multiplier input terminal, a second voltage multiplier input terminal, a first voltage multiplier output terminal, and a second voltage multiplier output terminal, the first and the second voltage multiplier input terminals are used to receive the AC voltage, and the first and the second voltage multiplier output terminals are used to output the driving DC power source.

3. The driving device of an LED according to claim 1, wherein the dimming driving unit is an LED driving chip.

4. The driving device of an LED according to claim 1, wherein the dimmer at least comprises a Tri-electrode AC switch (TRIAC).

5. A lighting apparatus of a Light Emitting Diode (LED), comprising:
a dimming control unit, comprising:
a dimmer, for producing a dimming power source according to a conducting condition; and
a transformer unit, coupled to the dimmer, for receiving the dimming power source, and adjusting the dimming power source to be an Alternating Current (AC) power source; and
a driving device, comprising:
a dimming driving unit, for receiving a driving Direct Current (DC) power source, so as to drive and adjust the brightness of a light source of an LED unit; and
a voltage multiplier unit, coupled to the dimming control unit and the dimming driving unit, for receiving the AC power source, and multiplying the AC power source and transforming the AC power source into the driving DC power source according to a power specification of the dimming driving unit.

6. The lighting apparatus of an LED according to claim 5, wherein the dimming driving unit is an LED driving chip.

7. The lighting apparatus of an LED according to claim 5, wherein the voltage multiplier unit comprises a first voltage multiplier input terminal, a second voltage multiplier input terminal, a first voltage multiplier output terminal, and a second voltage multiplier output terminal, the first and the second voltage multiplier input terminals are used to receive the AC voltage, and the first and the second voltage multiplier output terminals are used to output the driving DC power source.

8. The lighting apparatus of an LED according to claim 5, wherein the dimmer at least comprises a Tri-electrode AC switch (TRIAC).

9. The lighting apparatus of an LED according to claim 5, wherein the driving device and the LED unit are an LED bulb of the lighting apparatus, and the dimming control unit is a dimming switch and a base frame part of the LED bulb.
